(19) United States
(12) Patent Application Publication
(10) Pub. No.: US 2008/0232112 A1
(43) Pub. Date: Sep. 25, 2008

(54) Lighting Unit

(75) Inventors: Jaime Huizar, Juarez (MX); Victor Manuel Jurado, Juarez (MX)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/064,090

(22) PCT Filed: Aug. 17, 2006
(86) PCT No.: PCT/IB2006/052841

§ 371 Date: Feb. 19, 2008

(30) Foreign Application Priority Data
Aug. 23, 2005 (EP) 05107733.7

(51) Int. Cl. F21V 7/00; H01J 9/02; F21V 29/00

(52) U.S. Cl. 362/310; 445/26; 362/294

(57) ABSTRACT

A lighting unit (10) including a reflector region (130) coupled to a neck region (140) coupled to a base region (150) is described. These regions (130, 140, 150) define an inner region (160) for inclusion of a lamp (300), in that the reflector region (130) can be operated to reflect radiation generated by the lamp (300), the neck region (140) is disposed at least partially to surround the lamp (300), and the base region (150) is disposed to convey electrical connections to the lamp (300). The unit (10) further includes a heat-conducting arrangement of elements (500, 510) to conduct, in operation, heat energy generated by the lamp (300) substantially to the neck region (140) for subsequent dissipation therefrom.

### FIELD OF THE INVENTION

The present invention relates to lighting units including halogen lamps. Moreover, the present invention also concerns methods of fabricating such lighting units including halogen lamps.

### BACKGROUND OF THE INVENTION

Lighting units including halogen lamps are generally known and are contemporarily employed in widespread applications in which a relatively high illumination flux is required, for example in image projectors, domestic lighting, and in vehicle lighting. A halogen lamp comprises an electrically conductive wire filament supported by electrodes within a quartz envelope. The envelope is sealed and includes therein halogen gas at a relative high pressure, for example in the order of 6 Bars. The electrodes provide electrical connections from a region external to the envelope to the filament within the envelope.

In operation, an electrical current is passed through the wire filament causing it to be heated to white heat. On account of heat conduction from the wire filament through the halogen gas to the quartz envelope, the envelope attains a relative high temperature of several hundred degrees Centigrade in use. On account of such thermal conduction, the thermal design of halogen lamps is a significant issue, especially at a lower region of the lamp where the electrodes are conveyed through the envelope. The halogen lamp needs careful handling prior to use to prevent contamination being deposited on an exterior surface of the quartz envelope, such contamination resulting in undesirable temperature gradients in the lamp and hence potential premature lamp failure.

For convenience of use, especially to circumvent aforesaid contamination, it is contemporary practice to include quartz-envelope halogen lamps within secondary envelopes forming an exterior part of corresponding lighting units. Such secondary envelopes beneficially include metal-coated optically reflective surfaces and optical lenses, which can be operated to reflect optical radiation generated by their halogen lamps into beams of optical radiation. For example, an electric lamp/reflector unit is described in an international PCT patent application no. PCT/IB2003/005118 (WO 2004/049392). The electrical lamp/reflector unit comprises a double-ended halogen lamp whose quartz envelope is coated with an infrared film to reflect infrared energy produced by a filament of the halogen lamp back to the filament, thereby rendering the lamp more energy efficient. The unit comprises the aforesaid double-ended halogen lamp arranged in a reflector body in a manner in which a first end portion of the lamp is at least partially situated within a reflecting portion of the reflector body. The halogen lamp is disposed in the reflector so that an elongated axis of the halogen lamp substantially aligns to an optical axis of the reflector. The reflector includes a lens at its first end to refract light radiation generated at the halogen bulb into a beam of optical radiation. Moreover, the reflector includes the aforesaid reflecting portion adjacent to the lens, a neck portion adjacent to the reflecting portion and remote from the lens, and a base portion including external electrical contacts. At the neck region of the reflector and abutting onto the base portion, there is also a ceramic insert occupying a region between the first end portion of the lamp and an inside wall of the neck. Moreover, at the neck region, there is also a mounting ring spatially between the lamp and the ceramic insert to ensure that the lamp is correctly laterally positioned with the neck region. The ceramic insert is substantially of cylindrical shape with four distinct sectors. A cross-profile hole through a central axis of the ceramic insert is provided to accommodate relatively rigid electrical connected wires for connection from the external electrical contacts of the base portion of the reflector to the halogen lamp. The ceramic insert is made from steatite, aluminum oxide, aluminum nitride or similar heat conducting but substantially electrically insulating materials. The Steatite is, for example, L3-type Steatite comprising a mixture of silicon dioxide (SiO₂), Manganese Oxide (MnO) and barium oxide (BaO). When the reflector is in operation, the ceramic insert assists in dissipating heat from the first end portion of the lamp substantially to the base portion, thereby increasing the lamp operating lifetime by reducing the lamp to a favorable operating temperature when included within the reflector; such a lower temperature reduces a risk of a split pinch. In order to perform such a function most efficiently, the ceramic insert is beneficially arranged to occupy a region at a base of the reflector, prior to the base portion.

A further approach to cooling halogen lamps is described in a published U.S. patent application no. US 2005/0146257, in which a ceramic heat sink monolith is included at a pinch region of a halogen lamp. The monolith comprises a block and an array of spaced posts projecting outwardly from the block. The block comprises a cavity that has a recessed inner surface shaped to mate to the pinch region. Moreover, the cavity includes an opening that allows electrical connections to the halogen lamp to pass through.

A technical problem encountered with lighting units described in the foregoing is that the units including halogen lamps become more costly and complex to manufacture and that heat removal from halogen lamps is not optimally implemented.

### SUMMARY OF THE INVENTION

An objective of the present invention is to provide an improved lighting unit, which is potentially less costly to manufacture and has improved operating characteristics.

According to a first aspect of the present invention, there is a lighting unit including a reflector region coupled to a neck region coupled to a base region, these regions defining an inner region for including a lamp, in which the reflector region can be operated to reflect radiation generated by the lamp, the neck region is disposed at least partially to surround the lamp, and the base region is disposed to convey electrical connections to the lamp, the unit further including a heat-conducting arrangement of elements to conduct, during operation, heat energy generated by the lamp substantially to the neck region for subsequent dissipation therefrom.

The invention is of advantage in that inclusion of the heat-conducting arrangement of elements is capable of improving heat dissipation management within lighting units.

Optionally, in the lighting unit, the neck region is provided on its exterior surface with a plurality of flutes to assist convection cooling therefrom in operation. Inclusion of such flutes imparts other desirable characteristics to the lighting unit in addition to enhanced heat dissipation by convection.

Optionally, in the lighting unit, the heat-conducting arrangement of elements comprises a ceramic insert and a positioning ring. Such a combination of components assists in rendering manufacture the lighting unit potentially easier as well as providing for improved thermal management within the lighting unit.

More optionally, in the lighting unit, the neck region is provided with a tapered inner surface and the ceramic insert is provided with a tapered outer surface, said tapered inner surface and said tapered outer surface being arranged to cooperate to define a position of the ceramic insert within the neck region whilst providing for heat conduction across it. Use of the tapered surfaces is capable of simplifying manufacture, whilst providing efficient and predictable heat conduction characteristics from the ceramic insert to the neck region.

More optionally, in the lighting unit, the ceramic insert includes a hole therein so formed as to cooperate with a pinch region of the lamp to provide for heat conduction from the pinch region to the neck region. Such a heat conduction path is susceptible to removing heat efficiently from a part of the lamp, which, in practice, is most likely to be prone to thermal fracture, for example on account of coefficient of thermal expansion mismatches between its electrode leads, its electrode wires and quartz material.

More optionally, in the lighting unit, the positioning ring is so shaped as to position the lamp in operation within the neck region, the positioning ring substantially abutting onto the ceramic insert and onto the inner surface of the neck region. Such disposition of the positioning ring is of benefit in that the lamp is thereby well supported in the neck region.

More optionally, in the lighting unit, the ceramic insert includes a hole therein to receive a pinch region of the lamp, in which the pinch region conveys all electrical connections through it to the lamp. Such an arrangement is beneficial in that it reduces a number of opaque components in front of the lamp and thereby results in enhanced light output from the lighting unit.

More optionally, in the lighting unit, the ceramic insert is made from electrically insulating ceramic, having a composition and physical properties substantially similar to a L3-type Steatite ceramic material. Moreover, the ceramic insert is optionally of a substantially cylindrical form, having an external side wall (700) subtending an angle of substantially 3.5° relative to a central axis of the insert (500), a largest lateral diameter of substantially 17.5 mm, an axial length (690) of substantially 13.5 mm and an internal radius (730) of substantially 6.6 mm.

More optionally, in the lighting unit, the positioning ring is made from one or more of types of stainless steel. Yet more optionally, the positioning ring has a diameter of substantially 17.33 mm and a thickness of substantially 0.25 mm. Yet more optionally, the position ring includes a substantially centrally position rectangular hole having edge dimensions of substantially 12.0 mm by 3.7 mm.

More optionally, in the lighting unit, the reflector region is provided with a lens for diffracting radiation emitted in operation by the lamp to generate a beam of radiation for emission from the lighting unit.

More optionally, in the lighting unit, the lens comprises a plurality of lenslets for providing for, in operation, a beam of substantially diffuse radiation to be emitted from the unit.

Optionally, in the lighting unit, the inner region is hermetically sealed. Such hermetic sealing is of benefit in that it reduces ingress of contaminants, for example moisture and oils, onto the lamp, such contaminants potentially interfering with operation of the lamp, and for example causing premature failure thereof.

Optionally, in the lighting unit, the lamp is a halogen lamp. Such halogen lamps are of benefit in that they are capable of providing an extended operating lifetime in comparison with other types of incandescent lamps, whilst providing relatively high optical radiation output.

According to a second aspect of the present invention, there is a ceramic insert for use in manufacturing a lighting unit according to the first aspect of the invention.

According to a third aspect of the present invention, there is a positioning ring for use in manufacturing a lighting unit according to the first aspect of the invention.

According to a fourth aspect of the invention, there is a method of manufacturing a lighting unit according to the first aspect of the invention, said lighting unit including a reflector region coupled to a neck region coupled to a base region, these regions defining an inner region to include a lamp, so that the reflector region can be operated to reflect radiation generated by the lamp, the neck region is disposed at least partially to surround the lamp, and the base region is disposed to convey electrical connections to the lamp, said method including a step of:

Assembling into the unit a heat-conducting arrangement of elements to conduct, in operation, heat energy generated by the lamp substantially to the neck region for subsequent dissipation therefrom.

Optionally, the method further includes a step of:

Including a ceramic insert in said heat-conductive arrangement of elements to provide for heat conduction from the lamp to the neck region.

It will be appreciated that features of the invention are susceptible to being combined in any combination without departing from the scope of the invention as defined by the accompany claims.

### DESCRIPTION OF THE DIAGRAMS

By way of example only, embodiments of the present invention will now be described with reference to the accompanying drawings in which:

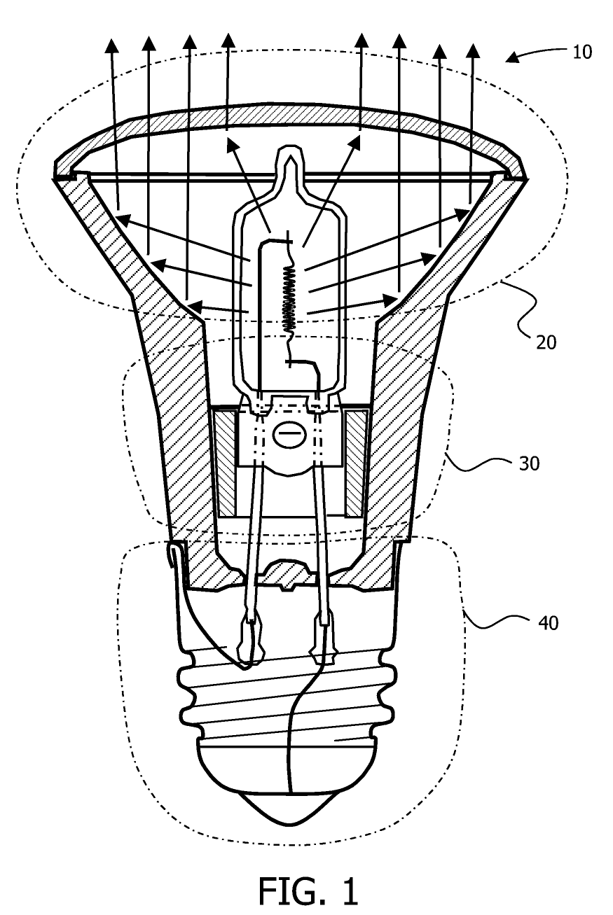

FIG. 1 is a cross-sectional schematic diagram of a lighting unit according to the present invention;

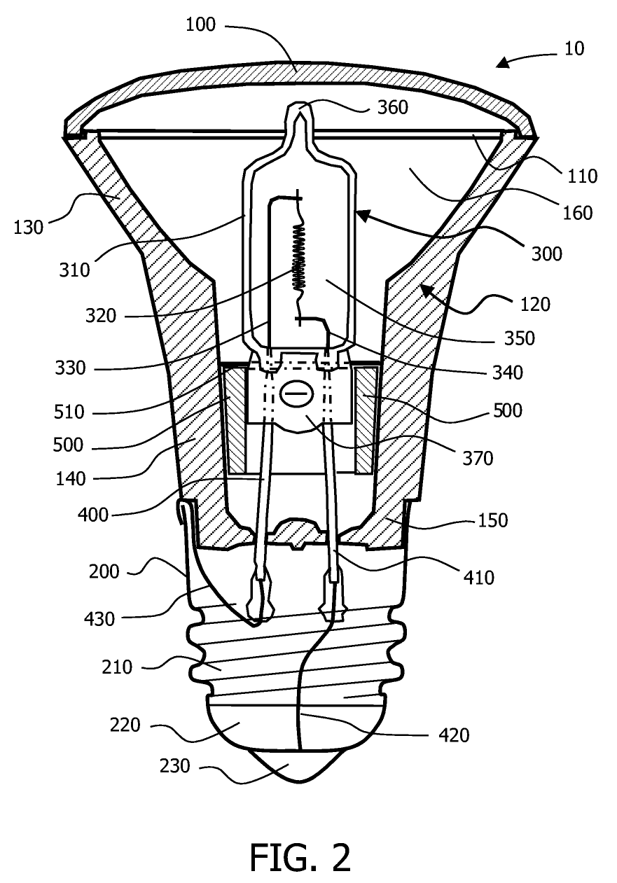

FIG. 2 is another cross-sectional schematic diagram of the lighting unit of FIG. 1;

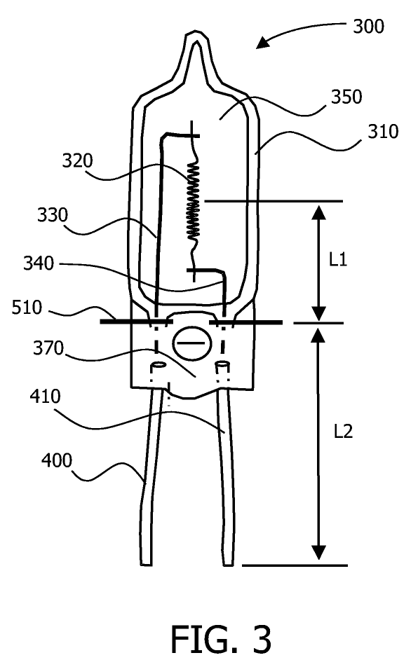

FIG. 3 is a schematic diagram of a halogen lamp together with its positioning ring included in the lighting unit of FIG. 1;

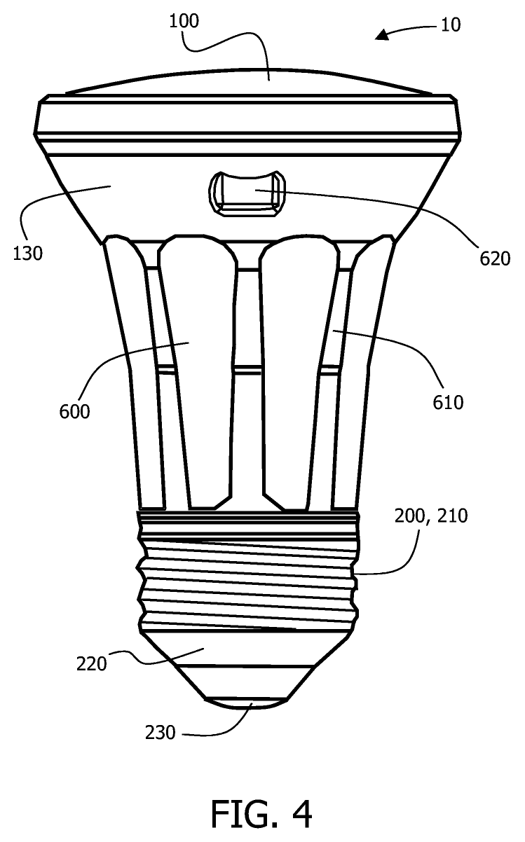

FIG. 4 is an external view of the lighting unit of FIG. 1;

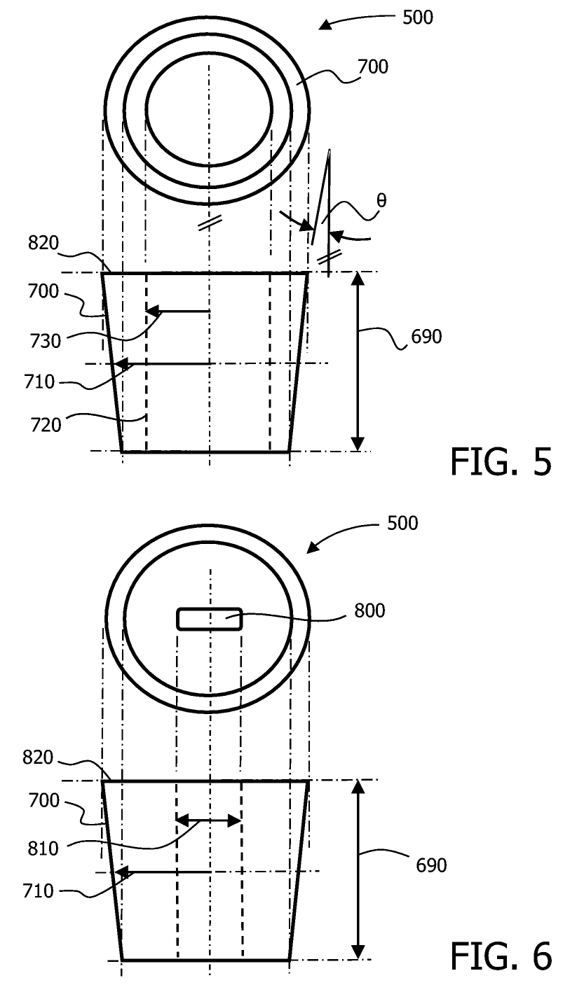

FIG. 5 is a schematic diagram of a ceramic insert of the lighting unit of FIG. 1;

FIG. 6 is a schematic diagram of the ceramic insert of FIG. 5 but adapted to include a slot hole for improved thermal conduction from a lamp; and

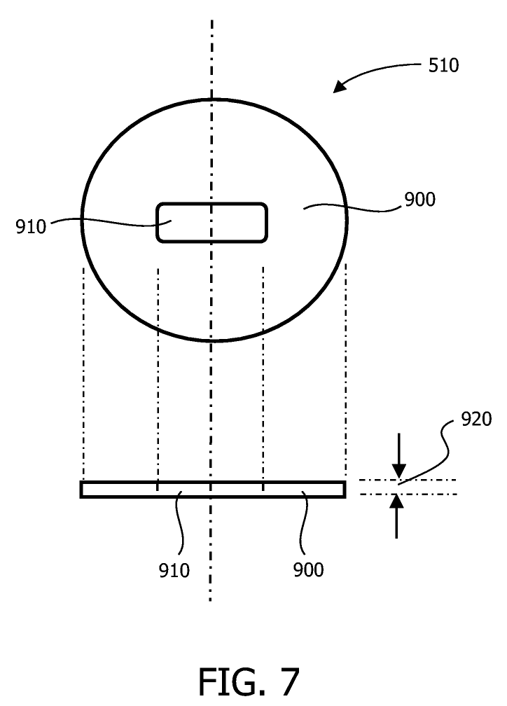

FIG. 7 is a schematic of the positioning ring also shown in FIG. 3.

### DESCRIPTION OF EMBODIMENTS OF THE INVENTION

Referring to FIG. 1, there is shown an embodiment of the invention, namely a lighting unit indicated generally by 10. The lighting unit 10 includes a reflector portion denoted by 20, a neck portion denoted by 30 and a base portion denoted by 40. In operation, the reflector portion 20 is a region in which light radiation is generated, reflected and then refracted to generate a beam of optical radiation. Moreover, in operation, the neck portion 30 provides mechanical support and also performs a cooling function. Furthermore, the base portion 40 is concerned with providing an Edison screw-type connection for coupling electrical power to the lighting unit 10.

Next, referring to FIG. 2, the lighting unit 10 will now be further elucidated regarding its component parts. The lighting unit 10 includes a domed substantially optically-transparent lens 100 to refract optical radiation to generate a beam of optical radiation from the unit 10 when in operation; optionally, the lens 100 is provided with a textured exterior surface, for example an array of lenslets, to provide a more diffuse quality to optical radiation transmitted through it. The domed lens 100 is attached at an interface 110 to a reflector indicated generally by 120. Optionally, the reflector 120 is attached securely to the lens 100 at the interface 110 by inclusion of epoxy adhesive at this point.

The reflector 120 comprises three distinct regions, namely a reflector region 130, a neck region 140 and a base region 150. The reflector 120 in cooperation with the lens 100 provides a sealed inner region denoted by 160. At the base region 150, the reflector 120 is attached to a base 200, for example by way of an epoxy adhesive or soldered interface. The base 200 includes a metal Edison-type screw thread 210 and has an insulator 220 at a bottom region thereof. A solder electrode 230 is provided at an extreme end of the insulator 220 as shown.

A halogen lamp indicated by 300 included within the reflector 120 and hence the sealed inner region 160. The halogen lamp 300 includes a quartz envelope 310, including a halogen gas 350 at an elevated pressure, for example at a pressure of about 6 Bars. Moreover, the halogen lamp 300 comprises a tungsten filament 320 supported on electrode wires 330, 340. The filament 320 is wound and mounted in an axial manner as illustrated; however, other orientations of the filament 320 are also feasible, for example a folded back “U”-type filament configuration. The halogen lamp 300 is of slightly elongated form and comprises a first elongated end terminating in a pointed projection 360 and a second elongated end terminating in a pinch region 370. The aforesaid electrode wires 330, 340 are conveyed through the pinch region 370 where they electrically couple to electrode leads 400, 410 respectively. The electrode leads 400, 410 are included in at least a part of the pinch region 370 and extend externally to the halogen lamp 300 as illustrated. The electrode leads 400, 410 project into the base 200 by way of holes provided in the base region 150 of the reflector 120, as illustrated, in which they are electrically coupled to flexible wires 430, 420 respectively. The flexible wires 430, 420 are electrically coupled to the Edison-type screw thread 210 and to the solder electrode 230 respectively. Moreover, the flexible wires 420, 430 are optionally made from nickel or nickel alloy. Furthermore, the flexible wire 430 is beneficially implemented as a fuse wire to reduce risk of damage to the lighting unit 10 and its environs under fault conditions. The insulator 220 can be operated to provide electrical isolation between the screw thread 210 and the solder electrode 230, so that electrical conduction between the screw thread 210 and the solder electrode 230 occurs in operation via the filament 320.

At the neck region 140 of the reflector 120, there is also a ceramic insert denoted by 500. The ceramic insert 500 is made from a standard electrical ceramic, for example substantially a type L3 Steatite ceramic material. Such a Steatite ceramic material comprises, for example, primarily a mixture of magnesium oxide, silicon oxide and aluminum oxide implemented as multi-component crystalline phases providing the material with an off-white appearance. Moreover, such a Steatite ceramic material exhibits a thermal conductivity in the range substantially 2 to 3 W/mK and a coefficient of thermal expansion substantially in the range 4 to 7 ppm/K. Optionally, the insert 500 is of an approximately cylindrical or ring-type form. If an inside surface of the neck region 140 is tapered from the reflector region 130 to the base region 150, the insert 500 optionally has an outer surface which tapered to cooperate with the tapered inside surface of the neck region 140. Such tapering is of benefit in that it defines during manufacture of the lighting unit 10 an extent to which the ceramic insert 500 can be pressed into the neck region 140. The ceramic insert 500 has an inside surface which is formed so as to abut onto, or to be in close proximity to, the pinch region 370 of the halogen lamp 300. Moreover, the ceramic insert 500 is so formed that it substantially does not encroach onto the base region 150 of the reflector 120 as illustrated. Above the ceramic insert 500, but abutting thereto, there is further included a positioning ring 510 made from a metal or metal alloy; optionally the positioning ring 510 is made from one or more types of stainless steel. The positioning ring 510 is so formed that it abuts onto the inside surface of the neck region 140 and cooperates with the pinch region 370 and the envelope 310 so as to centrally position the lamp 300 within the neck region 140. The envelope 310 in cooperation with the pinch region 370 serves to keep the positioning ring 510 in place within the neck region 140.

In operation, electrical current is passed through the filament 320 causing it to glow at substantially white heat. The halogen gas included within the quartz envelope 310 is also heated and heat energy dissipated at the filament 320 is conducted via the envelope 310 to the region 160. Moreover, heat energy reaching the envelope 310 is also conveyed through the electrode wires 330, 340 to the pinch region 370, which becomes especially heated. However, the ceramic insert 500 is effective in conducting heat from the pinch region 370 to the neck region 140, which, as will be elucidated in greater detail later, is provided with a fluted external service including a plurality of flutes orientated in a direction from the reflector region 130 to the base region 150. Inclusion of the plurality of flutes is especially effective in providing an enhanced external surface area to the neck region to improve air convection cooling; moreover, inclusion of the flutes provides a further advantage in rendering the neck region 140 mechanically robust whilst not making it too massive. Moreover, the positioning ring 510 serves not only to ensure that the lamp 310 is correctly positioned within the neck region 140 during manufacture, but also to ensure the lamp 300 remains correctly positioned in respect of the ceramic insert 500 when the lamp 300 is heated to a high temperature in operation. The positioning ring 510 also serves to reduce radiation heat energy from the lamp 300 being received by the ceramic insert 500 by either reflecting the heat energy back towards the lamp 300 or conducting the radiation heat energy to the neck region 140 in a similar manner to the ceramic insert 500. A further benefit in the operation of the lighting unit 10 depicted in FIG. 2 is that shunting of heat to the neck region 140 for convection dissipation therefrom assists in keeping the base portion 40 relatively cooler in operation. It is not unknown for Edison-screw sockets, often made from thermosetting resin, for example urea-formaldehyde resin, to be damaged by base portions of contemporary lighting units becoming excessively hot in operation. The present invention is capable of addressing such a problem encountered with such contemporary lighting units.

In FIG. 3, the lamp 300, together with its positioning ring 510, are optionally made with certain dimensions. An axial spacing L1 between a center of the filament 320 and a lateral plane through a central plane of the positioning ring 510 is optionally in the range 10 mm to 20 mm, more optionally in the range 12 mm to 16 mm, and most optionally substantially 14 to 23 mm. Moreover, an axial spacing L2 between the lateral plane through the central plane of the positioning ring 510 and an extreme end of the electrode leads 400, 410 is optionally in the range 20 mm to 35 mm, more optionally in range of 25 mm to 30 mm, and most optionally substantially 28 to 33 mm. Such dimensions give the lighting unit 10 desirable operating characteristics.

Referring next to FIG. 4, an external view of the lighting unit 10 is shown. In the neck region 140, there are shown aforementioned flutes, each flute comprising a cavity 600 surrounded on lateral sides thereof by flute walls 610. Each cavity 600 is optionally of substantially smoothly curved lateral cross-section to avoid abrupt stress-raising edges, which could give rise potentially to crack generation and hence cracking of the neck region 140 when exposed to repeated thermal cycling. The flutes optionally axially extend substantially from the reflector region 130 to the base portion 40 as illustrated. Moreover, there are optionally in the range 6 to 12 flutes on the external surface of the neck region 130, more optionally substantially 8 or 9 flutes. Optionally, the flutes are slightly wider at their upper ends approaching the reflector region 130 relative to their lower ends approaching the base portion 40 to improve convection cooling characteristics obtainable in operation. Optionally, the reflecting region 130 is provided on its exterior surface with one or more indent features 620, which assist in gripping the lighting unit 10 when being installed into, or extracted from, a light fitting.

The insert 500 and the ring 510 will now be further elucidated with reference to FIGS. 5, 6 and 7 as the ceramic insert 500 and the positioning ring 510 in combination provide the lighting unit 10 with beneficial thermal management by providing effective cooling to the neck region 140 rather than the base region 150. In FIGS. 5 and 6, the ceramic insert 500 optionally has an axial length 690 in the range 10 mm to 30 mm, and more optionally substantially 10 mm to 20 mm, and most optionally substantially in the range 12 mm to 15 mm. The ceramic insert 500 has an external tapering angle θ to its external tapered surface 700 in the range 0.5° to 10°, more optionally in the range 1° to 8°, and most optionally substantially in the range 2° to 5°. Moreover, the surface 700 has a mean radius 710 in the range 7 mm to 13 mm more optionally in the range 8 mm to 11 mm and most optionally substantially in the range 8 mm to 10 mm. Moreover, the inner surface, denoted by 720, of the insert 500 has a nominal radius 730 in the range 6 mm to 18 mm, more optionally in the range 6 mm to 13 mm and most optionally substantially in the range 6 mm to 8 mm; as elucidated in the foregoing, the radius 730 is selected so that the insert 500 can be in good thermal contact with the pinch region 370 of the lamp 300 in operation. In this respect, the insert 500 optionally includes a slotted hole 800 as depicted in FIG. 6 to surround the pinch region 370 of the lamp 300 more effectively, the hole having a slot width 810 corresponding to a width of the pinch region 370. Furthermore, the dimensions of the neck region 140 and of the insert 500 are generally chosen so that the insert will be kept positioned at a distance from the holes of the base region 150 of at least half the mean radius 710 of the insert. Variation of said distance influences the cooling effect of the insert.

Optionally, the ceramic insert 500 has a cylindrical form with a cone shape to the surface 700 with a surface angle θ of substantially 3.5°. The insert 500 also optionally has a diameter at its upper surface 820 of substantially 17.5 mm, and an axial length 690 of substantially 13.5 mm. More optionally, the ceramic insert 500 is provided with a cylindrical central hole in which the hole has a radius 730 of substantially 6.6 mm.

Moreover, the positioning ring 510 as depicted in FIG. 7 comprises a metallic substantially flat sheet in which a hole 910 is formed. The hole 910 is optionally of a slot-like form as shown to cooperate with the pinch region 370, although other shapes for the hole 910 are feasible. The positioning ring 510 is either made by a metal-sheet punching process or by photolithography processes followed by chemical etching. The positioning ring 510 has a thickness 920 in the range 0.1 mm to 2 mm thick, more optionally in the range 0.1 mm to 1 mm thick, and most optionally 0.15 mm to 0.35 mm thick. Optionally, the positioning ring 510 can be subjected to the following surface treatments to improve its thermal reflecting characteristics: polishing, plating. Moreover, the positioning ring 510 can be subjected to the following process during manufacture to ensure that it retains its desired physical shape and size when heated to a high temperature of several hundred degrees Centigrade when in operation: hardening.

Optionally, the ring 510 has a diameter of substantially 17.30 mm and a thickness 920 of 0.25 mm. Moreover, the hole 910 is optionally of rectangular format positioned at the center of the ring 510 and having edge dimensions of substantially 12.0 mm by 3.7 mm.

The ring 510 is designed to abut onto an upper surface 820 of the ceramic insert 500 when assembled into the lighting unit 10.

A process of assembling the lighting unit 10 during manufacture will be briefly described. The reflector 120 is mounted into a support without the lens 100 being fitted. The ceramic insert 500 is then offered into the neck region 140 and allowed to slide into position within the neck region 140 so that the tapered surface 700 abuts onto a tapered inner surface of the neck region 140. Thereafter, the positioning ring 510 is dropped into position within the neck region 140 to rest on an upper surface 820 of the insert 500 and laterally abut onto the tapered inner surface of the neck region 140. Next, the lamp 300 is offered into the holes 800, 910 of the insert 500 and the positioning ring respectively so that its electrode leads 400, 410 pass through corresponding holes in the base region 150 of the reflector 120; optionally, the electrode leads 400, 410 can be sealed to the base region 150 using epoxy adhesive, thereby rendering the region 160 potentially hermetically sealed when the aforesaid interface 110 is also provided with a hermetic seal. Thereafter, the flexible wires 420, 430 are attached to the electrode leads 400, 410. Next, the base portion 200 is attached to the reflector 120 and then connection of the flexible wires 420, 430 to the base portion 200 is completed. Finally, the lens 100 is added to the reflector 120 and the interface 110 appropriately sealed, for example using an epoxy adhesive or alternative sealing method; alternative methods include a peripheral sealing clamp or ring.

It will be appreciated that steps of the process can be performed in a different sequence to that described in the immediate foregoing paragraph. For example, the lamp 300, the positioning ring 510 and the insert 500 can be assembled together as a convenient sub-unit before this sub-unit is assembled into the reflector 120.

The lighting unit 10 is susceptible to being automatically assembled using robotic equipment or otherwise adapted production machinery. Alternatively, the lighting unit 10 is susceptible to at least partial manual assembly, which is attractive in countries having relatively lower hourly labor costs.

Improved thermal management implemented in the lighting unit 10 pursuant to the present invention is capable of improving the operating lifetime and operating reliability of the lighting unit 10. Moreover, components used for achieving such improved thermal management are also capable of rendering the lighting unit 10 more straightforward to assemble during manufacture, thereby potentially reducing production costs. It will thus be appreciated that the present invention provides considerable technical benefits.

Although embodiments of the present invention described in the foregoing are elucidated in connection with halogen lamps, it will be appreciated that the present invention is also applicable to other type of incandescent lamps housed within the reflectors.

Modifications to embodiments of the invention described in the foregoing are possible without departing from the scope of the invention as defined by the accompanying claims.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural and vice versa.

Numbers included within parentheses in the accompanying claims are intended to assist understanding of the claims and should not be construed in any way to limit the subject matter claimed by these claims.

1. A lighting unit (10) including a reflector region (130) coupled to a neck region (140) coupled to a base region (150), these regions (130, 140, 150) defining an inner region (160) for including a lamp (300), wherein the reflector region (130) can be operated to reflect radiation generated by the lamp (300), the neck region (140) is disposed at least partially to surround the lamp (300), and the base region (150) is disposed to convey electrical connections to the lamp (300), the unit (10) further including a heat-conducting arrangement of elements (500, 510) to conduct, in operation, heat energy generated by the lamp (300) substantially to the neck region (140) for subsequent dissipation therefrom.

2. A lighting unit (10) as claimed in claim 1, wherein the neck region (140) is provided on its exterior surface with a plurality of flutes to assist convention cooling therefrom in operation.

3. A lighting unit (10) as claimed in claim 1, wherein said heat-conductive arrangement of elements (500, 510) comprises a ceramic insert (500) and a positioning ring (510).

4. A lighting unit (10) as claimed in claim 3, wherein the neck region (140) is provided with a tapered inner surface and the ceramic insert (500) is provided with a tapered outer surface (700), said tapered inner surface and said tapered outer surface (700) being arranged to cooperate to define a position of the ceramic insert (500) within the neck region (140) whilst providing for heat conduction across it.

5. A lighting unit (10) as claimed in claim 3, wherein in that the ceramic insert (500) includes a hole (800) therein so formed so as to cooperate with a pinch region (370) of the lamp (300) to provide for heat conduction from the pinch region (370) to the neck region (140).

6. A lighting unit (10) as claimed in claim 3, wherein the positioning ring (510) is shaped so as to position the lamp (300) in operation within the neck region (140), the positioning ring substantially abutting onto the ceramic insert (500) and onto the inner surface of the neck region (140).

7. A lighting unit (10) as claimed in claim 3, wherein the ceramic insert (500) includes a hole (800) therein to receive a pinch region (370) of the lamp (300), in that the pinch region (370) conveys through it all the electrical connections to the lamp (30).

8. A lighting unit (10) as claimed in claim 3, wherein the ceramic insert (500) is made from electrically insulating ceramic, having a composition and physical properties substantially similar to a L3-type Steatite ceramic material.

9. A lighting unit (10) as claimed in claim 3, wherein the positioning ring (510) is made from one or more of types of stainless steel.

10. A lighting unit (10) as claimed in claim 3, wherein the ceramic insert (500) is of a substantially cylindrical form having an external side wall (700) subtending a angle of substantially 3.5° relative to a central axis of the insert (500), a largest lateral diameter of substantially 17.5 mm, an axial length (690) of substantially 13.5 mm and an internal radius (730) of substantially 6.6 mm.

11. A lighting unit (10) as claimed in claim 3, wherein the positioning ring (510) has a diameter of substantially 17.33 mm and a thickness (920) of substantially 0.25 mm.

12. A lighting unit (10) as claimed in claim 11, wherein the position ring (510) includes a substantially centrally positioned rectangular hole, having edge dimensions of substantially 12.0 mm by 3.7 mm.

13. A lighting unit (10) as claimed in claim 1, wherein the reflector region (130) is provided with a lens (100) to diffract radiation emitted in operation by the lamp (300) to generate a beam of radiation for emission from the lighting unit (10).

14. A lighting unit (10) as claimed in claim 13, wherein the lens (100) comprises a plurality of lenslets for providing for, in operation, a beam of substantially diffuse radiation to be emitted from the unit (10).

15. A lighting unit (10) as claimed in claim 1, wherein the inner region (160) is hermetically sealed.

16. A lighting unit (10) as claimed in claim 1, wherein the lamp (300) is a halogen lamp (300).

17. A ceramic insert (500) for use in manufacturing a lighting unit (10) as claimed in claim 1.

18. A positioning ring (510) for use in manufacturing a lighting unit (10) as claimed in claim 1.

19. A method of manufacturing a lighting unit (10) as claimed in claim 1, said lighting unit including a reflector region (130) coupled to a neck region (140) coupled to a base region (150), these regions (130, 140, 150) defining an inner region (160) for including a lamp (300), wherein the reflector region (130) can be operated to reflect radiation generated by the lamp (300), the neck region (140) is disposed at least partially to surround the lamp (300), and the base region (150) is disposed to convey electrical connections to the lamp (300), said method including a step of:
Assembling into the unit (10) a heat-conducting arrangement of elements (500, 510) to conduct, in operation, heat energy generated by the lamp (300) substantially to the neck region (140) for subsequent dissipation therefrom.

20. A method as claimed in claim 19, said method further including a step of:
including a ceramic insert (500) in said heat-conducting arrangement of elements (500, 510) to provide for heat conduction from the lamp (300) to the neck region (140).
